(19) United States
(12) Patent Application Publication
(10) Pub. No.: US 2016/0198691 A1
(43) Pub. Date: Jul. 14, 2016

(54) FLEXIBLE ANIMAL SHOES

(71) Applicant: Leslie Emery, Vashon, WA (US)

(72) Inventor: Leslie Emery, Vashon, WA (US)

(21) Appl. No.: 14/932,894

(22) Filed: Nov. 4, 2015

Related U.S. Application Data
(63) Continuation-in-part of application No. 13/257,357, filed on Sep. 19, 2011, now abandoned.

(51) Int. Cl. A01L 3/00; A01L 7/02

(52) U.S. Cl. CPC A01L 3/00; A01L 7/02

(57) ABSTRACT

This invention relates generally to farriery, and, more specifically, to flexible animal shoes. Flexible animal shoe also functions as a hoof protection device. The hoof protection device includes a base, a cuff comprising one or more panels, and a means of securing the base and cuff to a hoof. The panels may be independently movable such that they lay at different angles to horizontal. May include one or more girdles configured to wrap around at least a portion of the cuff. Device includes one or more girdles configured to securably link the cuff with one or more anchor points of one or more anchor plates. Device includes an adjustable width base comprising an open and/or at least partially closed sole. Width can be adjusted by insertion of hoof, by girdle, and by positioning of panels.

### PRIORITY CLAIM

This application claims the benefit of U.S. Provisional Patent Application No. 61/170,662 filed Apr. 20, 2009 (our ref. EMRY-1-1001), U.S. Provisional Patent Application No. 61/325,469 filed Apr. 19, 2010 (our ref. EMRY-1-1001-1), and U.S. Nonprovisional patent application Ser. No. 13/257,357 filed Sep. 19, 2011 (our ref. EMRY-1-1001-2). The foregoing applications are incorporated by reference in their entirety as if fully set forth herein.

### FIELD OF THE INVENTION

This invention relates generally to farriery, and, more specifically, to flexible animal shoes.

### SUMMARY

This invention relates generally to farriery, and, more specifically, to flexible animal shoes. In some embodiments, the flexible animal shoe may include a hoof protection device. In one embodiment, a hoof protection device includes a base; and a cuff comprising one or more panels, wherein the hoof protection device is configured for securing with a hoof. In another embodiment, the hoof protection device includes one or more girdles configured to wrap around at least a portion of the cuff. In another embodiment, the hoof protection device includes one or more girdles configured to securably link the cuff with one or more anchor points of one or more anchor plates. In another embodiment, the hoof protection device includes an adjustable width base comprising an open and/or at least partially closed sole. In another embodiment, the hoof protection device includes a collar configured for securing with above a hoof. In another embodiment, the hoof protection device includes a grip sock interfaceable with the cuff and a hoof.

Some embodiments of the flexible animal shoe may include a collar. In some embodiments, the collar further includes: an upper strap with a first portion and a second portion, the first portion and second portions coupleable with a fastener; a lower strap with a first portion and a second portion, the first portion and second portions coupleable to the girdle; and a flexible vertical piece coupling the upper strap and lower strap. In other embodiments, the collar may be coupleable with the base or cuff of the shoe.

### BRIEF DESCRIPTION OF THE DRAWINGS

Embodiments of the present invention are described in detail below with reference to the following drawings:

FIG. 1 is a perspective view of a hoof protection device, in accordance with an embodiment of the invention;

FIG. 2 is a perspective view of one embodiment of a girdle of a hoof protection device, in accordance with embodiments of the invention;

FIG. 3 is a perspective view of one embodiment of a base and one embodiment of a girdle of a hoof protection device, in accordance with embodiments of the invention.

FIG. 4 is a perspective view of one embodiment of a girdle of a hoof protection device, in accordance with embodiments of the invention;

FIG. 5 is a perspective view of one embodiment of a girdle of a hoof protection device, in accordance with embodiments of the invention;

FIG. 6 is a perspective view of one embodiment of a girdle of a hoof protection device, in accordance with embodiments of the invention;

FIG. 7 is a perspective view of fasteners of a hoof protection device, in accordance with embodiments of the invention;

FIG. 8 is a perspective view of fasteners of a hoof protection device, in accordance with embodiments of the invention;

FIG. 9 is a perspective view of an anchor plate of a hoof protection device, in accordance with embodiments of the invention;

FIG. 10 is a perspective view of anchor points of a hoof protection device, in 40 accordance with an embodiment of the invention;

FIG. 11 is a perspective view of removably couplable anchor points of a hoof protection device, in accordance with embodiments of the invention;

FIG. 12 is a perspective view of one embodiment of an adjustable width base of a hoof protection device, in accordance with embodiments of the invention;

FIG. 13 is a perspective view of one embodiment of an adjustable width base of a hoof protection device, in accordance with embodiments of the invention;

FIG. 14 is a perspective view of one embodiment of an adjustable width base of a hoof protection device, in accordance with embodiments of the invention;

FIG. 15 is a perspective view of one embodiment of an adjustable width base of a hoof protection device, in accordance with embodiments of the invention;

FIG. 16 is a perspective view of a collar of a hoof protection device, in accordance with an embodiment of the invention;

FIG. 17 is a perspective view of a collar of a hoof protection device, in accordance with an embodiment of the invention; and

FIG. 18 is a perspective view of a grip sock of a hoof protection device, in accordance with an embodiment of the invention.

### DETAILED DESCRIPTION

This invention relates generally to farriery, and, more specifically, to flexible animal shoes.

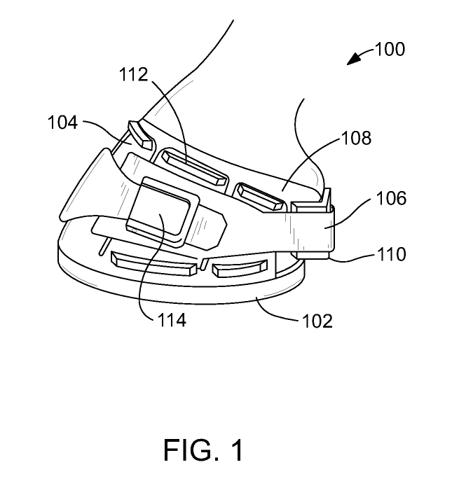

Specific details of certain embodiments of the invention are set forth in the following description and in FIGS. 1-18 to provide a thorough understanding of such embodiments. The present invention may have additional embodiments, may be practiced without one or more of the details described for any particular described embodiment, or may have any detail described for one particular embodiment practiced with any other detail described for another embodiment.

Importantly, a grouping of inventive aspects in any particular “embodiment” within this detailed description, and/or a grouping of limitations in the claims presented herein, is not intended to be a limiting disclosure of those particular aspects and/or limitations to that particular embodiment and/or claim. The inventive entity presenting this disclosure fully intends that any disclosed aspect of any embodiment in the detailed description and/or any claim limitation ever presented relative to the instant disclosure and/or any continuing application claiming priority from the instant application (e.g. continuation, continuation-in-part, and/or divisional applications) may be practiced with any other disclosed aspect of any embodiment in the detailed description and/or any claim limitation. Claimed combinations which draw from different embodiments and/or originally-presented claims are fully within the possession of the inventive entity at the time the instant disclosure is being filed. Any future claim comprising any combination of limitations, each such limitation being herein disclosed and therefore having support in the original claims or in the specification as originally filed (or that of any continuing application claiming priority from the instant application), is possessed by the inventive entity at present irrespective of whether such combination is described in the instant specification because all such combinations are viewed by the inventive entity as currently operable without undue experimentation given the disclosure herein and therefore that any such future claim would not represent new matter.

The present invention is comprised essentially of a base and a means by which the base is coupled with a hoof.

FIG. 1 is a perspective view of a flexible animal shoe and hoof protection device, in accordance with an embodiment of the invention. In some embodiments, hoof protection device 100 includes a base 102 and a cuff 104 including one or more panels, wherein the hoof protection device 100 is configured for securing with a hoof 108. In some embodiments, the one or more panels may be permanently coupled on at least one side to base 102. In other embodiments, the one or more panels may be removable coupled with base 102. In some embodiments, the one or more panels may be independently movable, such that one panel may lay at one angle to horizontal, and another panel may lay at a different angle to horizontal. In some embodiments, the one or more panels may be independent on three sides, wherein the fourth side is coupled with base 102. In other embodiments, the one or more panels may be independent on four sides, wherein at least one side is removably coupleable with one of base 102 or another of the one or more panels.

One purpose of the independently movable panels is to allow cuff 104 to lay flush against different parts of the hoof. This secures the shoe to the hoof, and also prevents intrusion of foreign objects between cuff 104 and the hoof, as foreign objects can cause irritation and injury to the animal. Hoofs grow inconsistently, so another purpose of the one or more independently movable panels is to allow cuff 104 to be reusable over time, as each panel adjusts individually to the surface of the hoof as the hoof grows. Another purpose of the one or more independently movable panels is to allow the hoof to slide easily into and out of cuff 104, preventing the use of a professional farrier and allowing the animal to go without shoes when that is optimal. Each panel bends, being fastened on only one side, which allows a user to move the panels out of the way of the hoof as it is inserted into or removed from the shoe. Another purpose of the one or more independently movable panels is to protect the hoof from impact injury, by laying flush against and covering the majority of the surface area of the hoof.

In some embodiments, the hoof protection device 100 may include one or more girdles 106 configured to wrap around at least a portion of the cuff 104. In some embodiments, girdle 106 may include a heel pad 110. In some embodiments, cuff 104 may include one or more guides 112 to guide girdle 106. In some embodiments, girdle 106 may be secured using a fastener 114. Accordingly, hoof protection device 100 is configurable to secure with a hoof 108 in a non-invasive manner. In some embodiments, girdle 106 may include an upper strap and a lower strap. In a further embodiment, the upper and lower straps may be coupled by fastener 114. In some embodiments, at least one of the upper strap or lower strap may include ridges. In some embodiments, girdle 106 and fastener 114 may be a ratcheting buckle or a ratchet strap. In other embodiments, fastener 114 may be a prong buckle, the prong of which may be disposed through a plurality of holes in girdle 106 straps. Girdle 106 and fastener 114 may be any number of strap and buckle systems without altering the function of the girdle and fastener.

In some embodiments, base 102 may be composed of plastic, metal, rubber, synthetic material, composite material, and/or a combination of the same. For example, base 102 may include a metal animal shoe inner portion covered with a durable rubber outer portion. Base 102 may include an exposed metal animal shoe and/or may be a metal animal shoe. Base 102 may have an open sole (e.g., shoe) and/or a closed sole (e.g., boot). Base 102 may include a flexible width adjustable using a girdle.

In some embodiments, cuff 104 may be composed of plastic, metal, rubber, synthetic material, composite material, and/or a combination of the same. Cuff 104 may include one uniform panel or two, three, four, five, or more panels. Cuff 104 may include multiple panels configured to overlap with adjacent panels or remain separate. Cuff 104 may be angly and tensionally biased against a hoof. Cuff 104 may be configured to rise to approximately an edge of a hoof.

In some embodiments, girdle 106 may be composed of leather, plastic, metal, fabric, a synthetic material, a composite material, and/or a combination of the foregoing. Girdle 106 may be composed of a wire, a cable, a woven strap, a leather strap, and/or a combination of the foregoing. Girdle 106 may be composed of a single piece and/or a plurality of pieces. Girdle 106 may include two or more girdles. Girdle 106 may be configured to circumscribe a cuff and/or partially circumscribe a cuff. Girdle 106 may have ends coupled to posterior portions of a base, that traverse across a base, and/or that are mounted under and/or within a base. Girdle 106 may be bias cut to fit substantially over a surface of a cuff. Girdle 106 may be coupled with a cuff and/or base and/or be separable from a cuff and/or base (e.g. coupled to a posterior portion of a base). Girdle 106 may be omitted with a cuff being adhesively coupled with a hoof. Girdle 106 may supplement adhesive coupling with a hoof.

In some embodiments, heel pad 110 may be composed of rubber, fabric, plastic, a synthetic material, a composite material, and/or a combination of the foregoing. Girdle 106 may be coupled and/or anchored to a base at or near the heel pad 110. Girdle 106 may be coupled and/or anchored to a cuff.

In some embodiments, guides 112 may be composed of rubber, metal, wood, plastic, a synthetic material, a composite material, and/or a combination of the foregoing. Guides 112 may be uniformly distributed along a top and/or bottom portion of a cuff. Guides 112 may be elongated, shortened, and/or assume any regular and/or irregular shape. Guides 112 may be adjustable, movable, slidable, and/or rotatable.

In some embodiments, fastener 114 includes a ratchet buckle fastener. Buckle fastener 114 may include one, two, three, or more fasteners. Buckle fastener 114 may include fasteners on opposing sides of a cuff. Buckle fastener 114 may be supplemented and/or complemented with adhesive, a button, a screw, a bolt, and/or other fastener. 5

In some embodiments, hoof protection device 100 may include reflective material and/or safety and/or decorative lighting positioned thereon. Lighting may be rechargeably powered by movement.

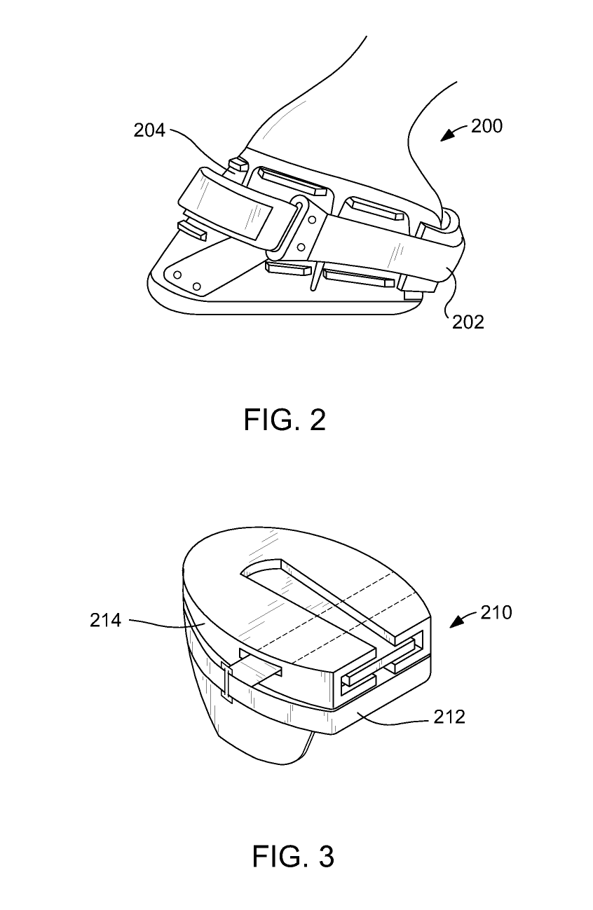

FIG. 2 is a perspective view of girdles of a hoof protection device, in accordance with embodiments of the invention. In some embodiments, hoof protection device 200 includes one or more girdles 202 configured to simply and/or compoundly wrap around at least a portion of cuff 204. In some embodiments, hoof protection device 210 includes one or more girdles 212 configured to traverse across at least a portion of a base 214.

In some embodiments, girdle 202 may be configured to simply wrap around at least a portion of a cuff (FIG. 1). In some embodiments, girdle 202 may be configured to compoundly wrap around at least a portion of a cuff with tension distribution downward, forward, backward, and/or upward. Girdle 202 may be configured to compoundly wrap around at least a portion of a cuff with one, two, or more points of tension distribution, which may or may not be mirrored on opposing sides.

In some embodiments, girdle 212 may be configured to traverse across an entire portion of a base. Girdle 212 may have ends that traverse across a portion of a base with the ends mounted on the base. Girdle 212 may have ends that traverse across a portion of a base with the ends crossed and mounted on the base. Girdle 212 may traverse under, through, around, and/or over a portion of the base. Girdle 212 may traverse across at least two different portions of the base.

FIG. 3 is a perspective view of guides of a hoof protection device, in accordance with embodiments of the invention. In some embodiments, hoof protection device 300 includes one or more girdles 302 configured to wrap around at least a portion of cuff 304 using one or more slot guides 306. In some embodiments, hoof protection device 310 includes one or more girdles 312 configured to wrap around at least a portion of cuff 314 using one or more post guides 316. In some embodiments, hoof protection device 320 includes one or more 6 girdles 322 configured to wrap around at least a portion of cuff 324 using one or more slit guides 326.

In some embodiments, slot guides 306 may include a slot in a cuff and/or a passageway coupled with a cuff. Slot guides 306 may be one, two, three, four, or more guides. Slot guides 306 may be disposed at posterior, side, and/or anterior positions on a cuff. Slot guides 306 may be positioned on a base. Slot guides 306 may be configurable to directing a girdle horizontal, vertical, angly, and/or a combination of the foregoing. Slot guides 306 may be openable, closable, movable, removable, shiftable, slidable, and/or anglable. Slot guides 306 may be configurable to directing a girdle around, below, over, and/or through a base and/or cuff.

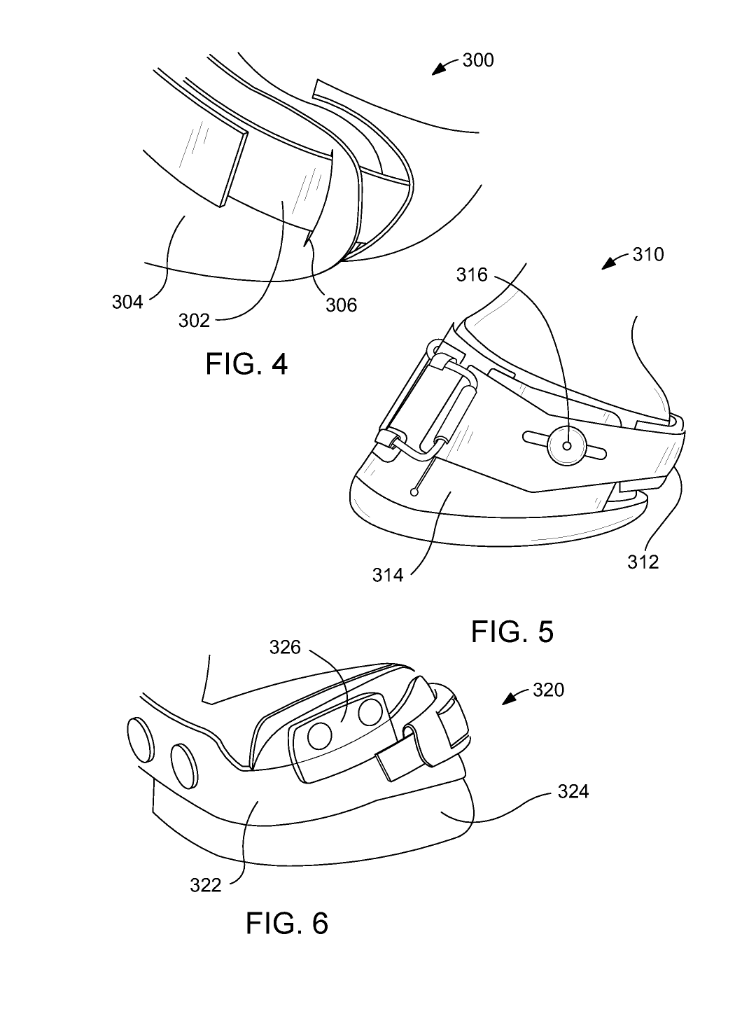

FIG. 4 is a perspective view of guides of a hoof protection device, in accordance with embodiments of the invention. In some embodiments, post guides 316 may include a prong, screw, bolt, and/or other extension. Post guides 316 may be coupled with a cuff and configured to extend through an orifice of a girdle. Post guides 316 may be coupled with a girdle and configured to extend through an orifice of a cuff. Post guides 316 may include a washer, button, or other retainer. Post guides 316 may be tightenable and/or loosenable. Post guides 316 may include one, two, three, or more guides. Post guides 316 may be positioned at posterior, side, and/or anterior positions on a cuff. Post guides 316 may be movable, removable, and/or anglable. Post guides 316 may be configurable to directing a girdle around, below, over, and/or through a base and/or cuff.

FIG. 5 is a perspective view of guides of a hoof protection device, in accordance with embodiments of the invention. In some embodiments, slit guides 326 may include a retainer configured to secure an edge of a girdle. Slit guides 326 may be composed of plastic, rubber, metal, wood, a synthetic material, a composite material, and/or a combination of the foregoing. Slit guides 326 may extend across a partial width of a girdle and/or extend across an entire width of a girdle. Slit guides 326 may be one, two, three, four, or more guides. Slit guides 326 may be disposed at posterior, side, and/or anterior positions on a cuff. Slit guides 326 may be positioned on a base. Slit guides 326 may be configurable to directing a girdle horizontal, vertical, angly, and/or a combination of the foregoing. Slit guides 326 may be openable, closable, movable, removable, shiftable, slidable, and/or anglable. Slit guides 326 may be tightenable and/or loosenable. Slit guides 326 may be configurable to directing a girdle around, below, over, and/or through a base and/or cuff.

In some embodiments, slot guides 306, post guides 316, slit guides 326, and other guides may be combined, supplemented, and/or omitted. Other guides may include a cuff having an internal channel, a groove or impression in a cuff, attachment of a girdle directly with a cuff, securable flaps of a cuff, edges of a cuff, brackets attachable with a cuff, holes in a base, fastenable straps or loops, or any other similar guide.

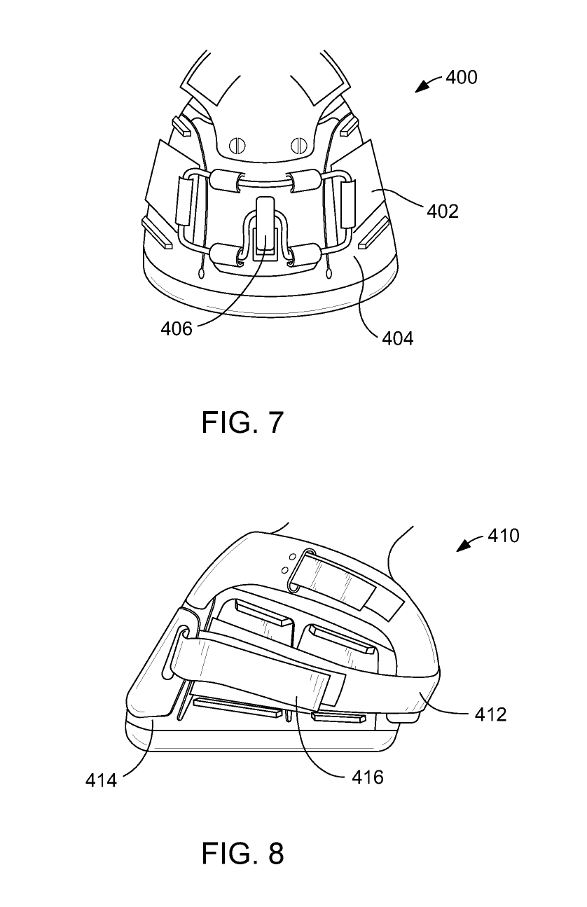

FIG. 7 is a perspective view of fasteners of a hoof protection device, in accordance with embodiments of the invention. In some embodiments, hoof protection device 400 includes one or more girdles 402 configured to wrap around at least a portion of a cuff 404 and tensionally secure using one or more cable fasteners 406. In some embodiments, hoof protection device 410 includes one or more girdles 412 configured to wrap around at least a portion of a cuff 414 and tensionally secure using one or more strap fasteners 416.

In some embodiments, cable fasteners 406 may include a binder buckle, a ratchet track, a worm drive, a reel dial, and/or any other fastener configurable to controllably tightening a cable. Cable fasteners 406 may be configured to pinch, pull, twist, stretch, or otherwise effectively adjust a length of a cable. Cable fasteners 406 may be positioned on a posterior, side, and/or anterior portion of a cuff and/or below or within a base. Cable fasteners 406 may include one, two, three, or more fasteners. Cable fasteners 406 may include a lock and/or removable cover portion. Cables may be a girdle, extend from a girdle, and/or couple with a girdle. Cable fasteners 406 may secure a girdle to an anchor and/or secure one end of a girdle to another end of a girdle.

FIG. 8 is a perspective view of fasteners of a hoof protection device, in accordance with embodiments of the invention. In some embodiments, strap fasteners 416 may include a hook and loop, double action strap binder, ratchet buckle, clasp, belt-type buckle and/or any other fastener configurable to controllably tightening a strap. Strap fasteners 416 may be positioned on posterior, side, and/or anterior portion of a cuff and/or below or within a base. Strap fasteners 416 may include one, two, three, or more fasteners. Strap fasteners 416 may secure a girdle to an anchor and/or secure one end of a girdle to another end of a girdle.

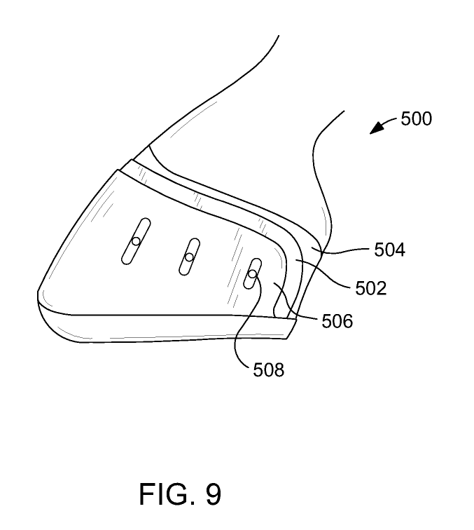

FIG. 9 is a perspective view of an anchor plate of a hoof protection device, in accordance with embodiments of the invention. In some embodiments, hoof protection device 500 includes one or more anchor plates 502 mountable on a hoof 504. In some embodiments, one or more anchor plates 502 mountable on a hoof 504 are configured for frictionally interfacing with a cuff 506. In some embodiments, one or more anchor plates 502 mountable on a hoof 504 are configured for fastening with a cuff 506.

In some embodiments, anchor plates 502 are mountable on a hoof using adhesive. Anchor plates 502 may include one, two, three, or more independent portions. Anchor plates 502 may be mountable to interface with only a portion of or substantially an entire surface area of a cuff Anchor plates 502 may be used in conjunction with other embodiments described herein, including a girdle and fastener.

In some embodiments, anchor plates 502 include are configured for frictionally interfacing with a cuff using surface irregularity, male and female components, hook and loop, adhesive, and/or other similar methodology. Anchor plates 502 may include one or more posts 508 configured to extend into and/or through one or more channels, depressions, and/or orifices of a cuff

In some embodiments anchor plates 502 are configured for fastening with a cuff. Anchor plates 502 may include one or more posts 508 that are configured to extend through one or more orifices of a cuff and securably receive nuts. Anchor plates 502 may include one or more embedded nuts that are configured to securably receive bolts extending through one or more orifices of a cuff.

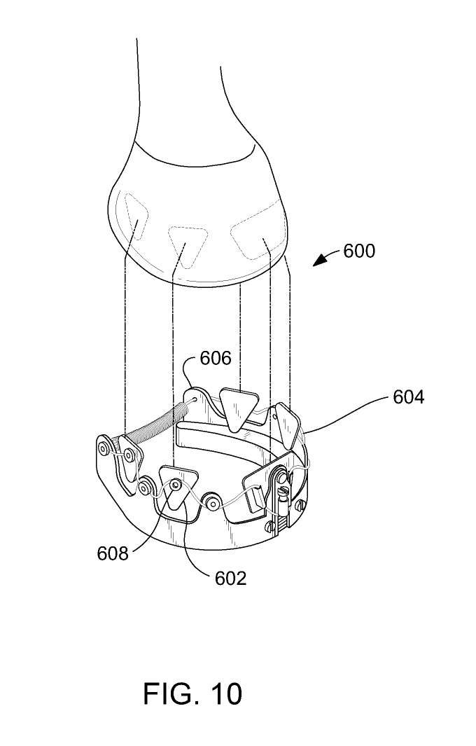

FIG. 10 is a perspective view of anchor points of a hoof protection device, in accordance with an embodiment of the invention. In some embodiments, hoof protection device 600 includes one or more anchor plates 602 mountable on a hoof. In some embodiments, hoof protection device 600 includes one or more girdles 604 configured to securably link cuff 606 with one or more anchor points 608 of the one or more anchor plates 602.

In some embodiments, anchor plates 602 are mountable on a hoof using adhesive. Anchor plates 602 may be composed of plastic, rubber, a composite material, a synthetic material, and/or a combination of the foregoing. Anchor plates 602 may include one, two, three, or more anchor plates. Anchor plates 602 may be uniformly and/or non-uniformly distributable on hoof. Anchor plates 602 may be of similar and/or different sizes and/or shapes. Anchor plates 602 may be at least partially exposed by contours of a cuff.

In some embodiments, anchor points 608 are hooks, prongs, ridges, channels, holes, edges, or other similar structures configured for receiving a girdle. Anchor points 608 may be composed of rubber, plastic, metal, wood, a composite material, a synthetic material, and/or a combination of the foregoing. Anchor points 608 may include one, two, three, or more anchor points. Anchor points 608 may include one, two, or more anchor points on one anchor plate. Anchor points 608 may be movable, removable, slidable, shiftable, and/or rotatable relative to an anchor plate.

In some embodiments, girdle 604 includes a cable configured to lace with anchor points. Girdle 604 may include a cable secured to an anchor point. Girdle 604 may include a parallel cable configured to lace with parallel anchor points. Girdle 604 may include a strap and/or a strap portion. Girdle 604 may include one, two, three, or more girdles. Girdle 604 may be coupled with and/or laceable with a cuff and/or base. Girdle 604 may circumscribe a cuff and include a pad and/or protective channel for interfacing with a hoof heel. Girdle 604 may traverse under, across, over, and/or through a base.

In some embodiments, cuff 604 includes a shape to accommodate anchor plates. Cuff 604 may include contours to configurable to substantially expose anchor plates. Cuff 604 may include contours configurable to substantially cover anchor plates. Cuff 604 may include contours configurable to substantially expose anchor points. Cuff 604 may include one or more orifices configurable to allowing anchor points to protrude through. Cuff 604 may include curved and/or sharply angled contours. Cuff 604 may also be substantially minimized.

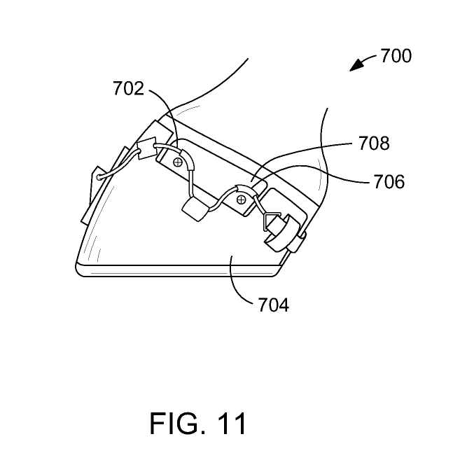

FIG. 11 is a perspective view of removably couplable anchor points of a hoof protection device, in accordance with embodiments of the invention. In some embodiments, hoof protection device 700 includes one or more girdles 702 configured to securably link cuff 704 with one or more anchor points 706 removably couplable with the one or more anchor plates 708. Accordingly, anchor plates 708 may be disposed on a hoof during and/or between uses of hoof protection device 700.

In some embodiments, anchor plates 708 may include one or more embedded bolts and/or nuts configured for removably securing an anchor point. Anchor plates 708 may include a flange or other similar structure for receiving a hook and/or clasp for removably securing an anchor point. Anchor plates 708 may include one or more depressions and/or extensions for snapping, interlocking, and/or mateably receiving an anchor point.

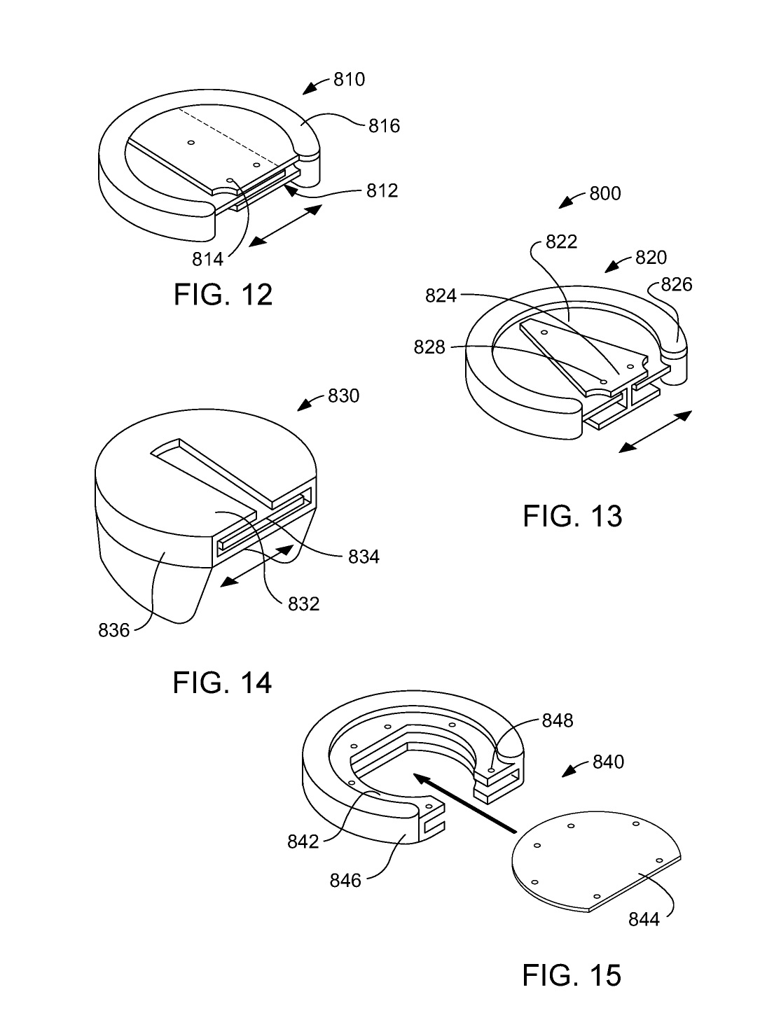

FIG. 12 is a perspective view of adjustable width bases of a hoof protection device, in accordance with embodiments of the invention. In some embodiments, hoof protection devices 800 include adjustable and securably adjustable width bases comprising open and/or at least partially closed soles. Hoof protection devices 800 may be composed of composed of metal, rubber, wood, plastic, a composite material, a synthetic material, and/or a combination of the foregoing. It should be noted that while different embodiments of base 102 are shown in FIG. 8, each of FIG. 8A, 8B, 8C, and 8D are an adjustable width base 102 as disclosed in FIG. 1.

In some embodiments, hoof protection device 810 includes three overlapping plates 812 expandable and/or contractible with opposing ends of base 816. Overlapping plates 812 may include two, three, four, or more overlapping plates. Overlapping plates 812 may include one or more apertures for exposing a hoof. For example, overlapping plates 812 may be limited in shape to that surrounding any fasteners. Overlapping plates 812 may be securable in alignment using one or more fasteners 814. Overlapping plates 812 may be securable in alignment in coordination with a girdle and/or an independent cinching mechanism. Overlapping plates 812 may be contractibly biased to automatically adjust to a hoof width. Overlapping plates 812 may include traction surface irregularity.

FIG. 13 is a perspective view of adjustable width bases of a hoof protection device, in accordance with embodiments of the invention. In some embodiments, hoof protection device 820 includes a split plate 822 insertable within a slotted tongue 824 expandable and/or contractible with opposing ends of base 826. Split plate 822 may include a slotted portion for overlapping above and/or below a slotted tongue. Slotted tongue 824 and split plate 822 may be fixedly and/or movably coupled anteriorly. Slotted tongue 824 may be removably couplable. Split plate 822 and/or slotted tongue 824 may include one or more apertures for exposing a hoof. For example, split plate 822 may be limited in shape to that surrounding any fasteners. Slotted tongue 824 may define a shape that extends more fully and/or fully across base. Split plate 822 and/or slotted tongue 824 may be securable in alignment using one or more fasteners 828. Split plate 822 and/or slotted tongue 824 may be securable in alignment in coordination with a girdle and/or an independent cinching mechanism. Split plate 822 and/or slotted tongue 824 may be contractibly biased to automatically adjust to a hoof width upon use. Split plate 822 and/or slotted tongue 824 may include traction surface irregularity.

FIG. 14 is a perspective view of adjustable width bases of a hoof protection device, in accordance with embodiments of the invention. In some embodiments, hoof protection device 830 includes a tongue 834 insertable within a slotted plate 832 expandable and/or contractible with opposing ends of base 836. Slotted plate 832 may be an extension of base. Tongue 834 and/or slotted plate 832 may be fixedly and/or movably coupled anteriorly. Tongue 834 and/or slotted plate 832 may be securable in alignment using one or more fasteners. Tongue 834 and/or slotted plate 832 may be securable in alignment in coordination with a girdle and/or an independent cinching mechanism. Slotted plate 832 may include rubber and/or elastic between opposing sides for coverage and/or provide tensional bias against opposing ends of base. Slotted plate 832 and tongue 834 may be contractibly biased to automatically adjust to a hoof width upon use. Slotted plate 832 may include traction surface irregularity.

FIG. 15 is a perspective view of adjustable width bases of a hoof protection device, in accordance with embodiments of the invention. In some embodiments, hoof protection device 840 includes a custom plate 844 insertable within a slotted plate 842 expandable and/or contractible with opposing ends of base 846. Slotted plate 842 and custom plate 844 may be securable in alignment using one or more fasteners 848. Custom plate 844 may embody various widths, diameters, perimeters curvatures, thicknesses, and/or other shapes. Custom plate 844 may include one or more apertures for exposing a hoof. Slotted plate 842 may extend partially around base and/or fully around base. Slotted plate 842 may be composed of independent sections. Slotted plate 842 may extend more fully and/or fully across base. Slotted plate 842 may have upper and/or bottom plates embodying different shapes. Slotted plate 842 and custom plate 844 may be securable in alignment in coordination with a girdle and/or an independent cinching mechanism. Slotted plate 842 and custom plate 844 may include traction surface irregularity. Custom plate 844 may be selected from an array of custom plate sizes and/or shapes.

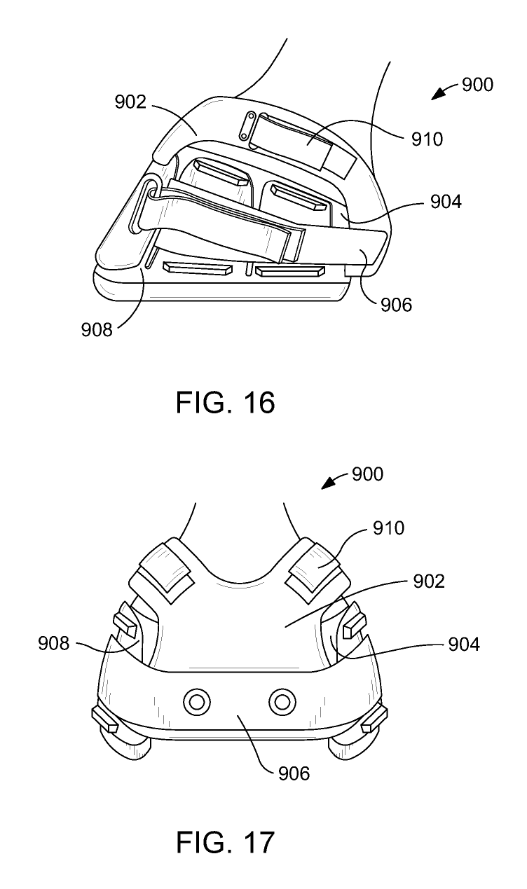

FIG. 16 and FIG. 17 are perspective views of a collar of a hoof protection device, in accordance with an embodiment of the invention. In some embodiments, hoof protection device 900 includes a collar 902 configured for securing with above a hoof 904.

In some embodiments, collar 902 is coupled with a girdle 906 posteriorly and a cuff 908 anteriorly and configured to secure using one or more fasteners 910 (e.g., single yoked collar or double yoked collar). It is to be noted that girdle 906 may be interchangeable with girdles 106, 202, 212, 302, 312, 402, 412, 604, and 702. Collar may be composed of leather, rubber, an elastic/stretch material, fabric, a synthetic material, a composite material, and/or a combination of the foregoing. Collar 902 may include one or more internal pads. Collar 902 may be coupled only with a girdle and/or only with a cuff. Collar 902 may be coupled at different positions with a girdle and/or a cuff. Collar 902 may be removably couplable with a girdle and/or cuff. Collar 902 may be at least partially positioned over a cuff, at a point just above a cuff, and/or at a point substantially above a cuff. Collar 902 may include two or more parallel and/or independent collars. Fasteners 910 may include two or more fasteners. Fasteners 910 may be omitted and collar may embody a sleeve and/or loop. Fasteners 910 may include a hook and loop, double back buckle, button, ratchet buckle, and/or a combination of the foregoing.

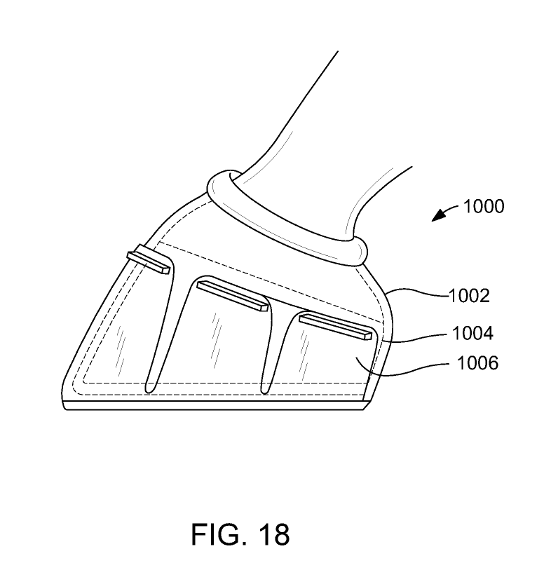

FIG. 18 is a perspective view of a grip sock of a hoof protection device, in accordance with an embodiment of the invention. In some embodiments, hoof protection device 1000 includes a grip sock 1002 interfaceable with a cuff 1006 and a hoof 1004. FIG. 18 also shows that the one or more panels of cuff 1006, and also cuff 104, are, in some embodiments, independent on three sides while being coupled with a base such that each panel can be independently tensioned against the surface of a hoof.

In some embodiments, grip sock 1002 is a sleeve disposable between a hoof 1004 and a cuff 1006. Grip sock 1002 may be composed of rubber, plastic, fabric, foam, a compressible material, an elastic material, a synthetic material, a composite material, and/or a combination of the foregoing. Grip sock 1002 may embody a contoured shape for sizing to a hoof. Grip sock 1002 may include an elastic upper rim.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of this subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “ a system having at least one of A, B, and C” would include but not be limited to systems that have A alone, B alone, C alone, A and B together, A and C together, B and C together, and/or A, B, and C together, etc.).

While preferred and alternative embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. A flexible animal shoe, comprising:
a base, the base including at least an adjustable width defining at least one perimeter;
two or more overlapping plates, the two or more overlapping plates disposed within an interior perimeter of the base and defining an at least partially closed sole, wherein the adjustable width of the base is adjusted by slidably aligning the two or more overlapping plates relative to the at least one perimeter defined by the base, the adjustment operable to at least one of increase or decrease a degree of overlap among the two or more overlapping plates to accommodate varying widths of hoof; and
a cuff, the cuff including at least two independent panels coupled with the base along at least a portion of an exterior perimeter of the base; and
at least one girdle configured to securably wrap around at least a portion of the cuff.

2. The flexible animal shoe of claim 1, wherein the adjustable width of the base is fixable by securably aligning the two or more overlapping plates.

3. The flexible animal shoe of claim 1, wherein the adjustable width of the base is contractibly biased.

4. The flexible animal shoe of claim 1, wherein the at least one girdle is comprised of:
at least one lower strap;
at least one upper strap, the at least one upper strap coupled with the at least one lower strap; and
at least one fastener, the at least one fastener securably coupled with the at least one lower strap and adjustably coupled with the at least one upper strap.

5. The flexible animal shoe of claim 4, wherein the at least one upper strap is ridged, wherein at least one ridge includes at least an anchor point for receiving at least a portion of a fastener.

6. The flexible animal shoe of claim 1, wherein at least one girdles securably wrap around the entire circumference of the hoof.

7. The flexible animal shoe of claim 1, wherein the at least one girdles include a heel pad.

8. The flexible animal shoe of claim 1, wherein the adjustable width of the base is fixable by securably wrapping the at least one girdles around at least a portion of the cuff.

9. The flexible animal shoe of claim 1, wherein the adjustable width of the base is fixable by securably wrapping the at least one girdles around the entire circumference of the hoof.

10. The flexible animal shoe of claim 1, wherein the cuff including at least two independent panels comprises at least two independent panels configured to at least partially overlap.

11. The flexible animal shoe of claim 1, wherein the cuff including at least two independent panels comprises at least two independent panels configured to at least partially cover a hoof wall.

12. The flexible animal shoe of claim 1, wherein the cuff including at least two independent panels comprises at least two independent panels configured to cover an entire hoof wall.

13. The flexible animal shoe of claim 1, wherein securably wrapping at least one girdles around at least a portion of the cuff is operable to constrict the at least two independent panels about the hoof.

14. The flexible animal shoe of claim 6, wherein securably wrapping at least one girdles around at least a portion of the cuff is operable to constrict the at least two independent panels about the hoof, the at least two independent panels precisely following a contour of the hoof.

15. The flexible animal shoe of claim 6, wherein securably wrapping at least one girdles around at least a portion of the cuff is operable to constrict the two independent panels about the hoof, fixing the adjustable width of the base around the circumference of the hoof.

16. A flexible animal shoe, comprising:
a base, the base including at least an adjustable width defining at least one perimeter;
two or more overlapping plates, the two or more overlapping plates disposed within an interior perimeter of the base and defining an at least partially closed sole, wherein the adjustable width of the base is adjusted by slidably aligning the two or more overlapping plates relative to the at least one perimeter defined by the base, the adjustment operable to at least one of increase or decrease a degree of overlap among the two or more overlapping plates to accommodate varying widths of hoof;
a cuff, the cuff including at least two independent panels coupled with the base along at least a portion of an exterior perimeter of the base; and
wherein the two independent panels are constricted against the surface of the hoof.

17. A flexible animal shoe, comprising:
a base, the base including at least an adjustable width defining at least one perimeter;
two or more overlapping plates, the two or more overlapping plates disposed within an interior perimeter of the base and defining an at least partially closed sole, wherein the adjustable width of the base is adjusted by slidably aligning the two or more overlapping plates relative to the at least one perimeter defined by the base, the adjustment operable to at least one of increase or decrease a degree of overlap among the two or more overlapping plates to accommodate varying widths of hoof;
a cuff, the cuff including at least two independent panels coupled with the base along at least a portion of an exterior perimeter of the base; and
wherein the two independent panels conform to the surface of the hoof.

18. The flexible animal shoe of claim 17, further comprising:
a collar coupled with the girdle, the collar further including:
an upper strap with a first portion and a second portion, the first portion and second portions coupleable with a fastener;
a lower strap with a first portion and a second portion, the first portion and second portions coupleable to the girdle; and
a flexible vertical piece coupling the upper strap and lower strap.
